(19) United States
(12) Patent Application Publication
(10) Pub. No.: US 2013/0145629 A1
(43) Pub. Date: Jun. 13, 2013

(54) Inner Cutter For Rotary Shaver

(71) Applicant: ROVCAL, LLC, Madison, WI (US)

(72) Inventor: Maciej Murzynski, Verona, WI (US)

(73) Assignee: ROVCAL, LLC, Madison, WI (US)

(21) Appl. No.: 13/707,843

(22) Filed: Dec. 7, 2012

Related U.S. Application Data
(60) Provisional application No. 61/568,771, filed on Dec. 9, 2011.

(51) Int. Cl. B26B 19/14; B26B 19/38

(52) U.S. Cl. CPC B26B 19/141; B26B 19/3893
USPC 30/346.51; 72/336

(57) ABSTRACT

A blade for an inner cutter of a rotary shaver generally includes an annular base plate and a plurality of cutting units spaced about the base plate. Each of the cutting units has a pair of generally radially spaced-apart cutting edges and an orientation axis. The orientation axes define a plurality of differently angled spaces about the blade.

### CROSS-REFERENCE TO RELATED APPLICATIONS

This application claims the benefit of U.S. Provisional Application No. 61/568,771 filed Dec. 9, 2011, which is incorporated herein in its entirety.

### BACKGROUND

The present invention relates generally to electric shavers and, more particularly, to an inner cutter for a rotary electric shaver.

Rotary electric shavers conventionally include a handle and a head mounted on the handle, and the head carries two or more sets of paired inner and outer cutters. The outer cutters, which are typically cup-shaped, are supported by a frame of the shaver head and typically define skin contacting surfaces of the shaver. Openings or slots formed in the outer cutters allow hair to protrude through the outer cutters as the shaver head is moved over the skin. Each inner cutter is housed in the shaver head below a respective outer cutter and in sliding engagement with the inner surface of the outer cutter. The inner cutters are rotatably driven by an electric motor, typically housed within the handle, whereby rotation of the inner cutters facilitates cutting hairs that protrude through the outer cutters.

In many current rotary electric shaver constructions, each inner cutter has a plastic drive cap and metallic blade fastened to the drive cap. The drive cap is configured to connect the inner cutter to a drive shaft operably coupled to the motor. The configuration of the blade can affect shaving efficiency and comfort, along with the cost of manufacturing the inner cutter.

There is a need, therefore, for an inner cutter that provides an efficient and comfortable shaving experience, as well as a lower manufacturing cost.

### SUMMARY OF THE INVENTION

In one embodiment, a blade for an inner cutter of a rotary shaver generally includes an annular base plate and a plurality of cutting units spaced about the base plate. Each of the cutting units has a pair of generally radially spaced-apart cutting edges and an orientation axis. The orientation axes define a plurality of differently angled spaces about the blade.

In another embodiment, a blade for an inner cutter of a rotary shaver generally includes an annular base plate and a plurality of cutting units spaced about the base plate. Each of the cutting units includes a projecting segment extending generally upwardly from the base plate and a cutting member extending generally radially from the projecting segment. A lower relief is defined at a lower junction of the projecting segment and the cutting member.

In yet another embodiment, a blade for an inner cutter of a rotary shaver generally includes an annular base plate and a plurality of cutting units spaced about the base plate. Each of the cutting units has a front surface, a back surface, and a top surface extending from the front surface to the back surface. The top surface has a planar contact portion and a planar noncontact portion that are obliquely oriented relative to one another.

In yet another embodiment, a method of manufacturing a blade for an inner cutter of a rotary shaver generally includes stamping a blade formation from a sheet of metallic material. The blade formation includes a base plate formation and a connecting segment formation joined to the base plate formation with a first pair of reliefs disposed on opposite sides of the connecting segment formation at the base plate formation. The blade formation further includes a projecting segment formation joined to the connecting segment formation and a cutting member formation joined to the projecting segment formation with a second pair of reliefs disposed on opposite sides of the projecting segment formation at the cutting member formation. The method also generally includes bending the projecting segment formation relative to the connecting segment formation such that the projecting segment formation extends generally upward relative to the connecting segment formation. The method also generally includes bending the cutting member formation relative to projecting segment formation such that the cutting member formation extends generally radially from the projecting segment formation.

### BRIEF DESCRIPTION OF THE DRAWINGS

FIG. 1 is a perspective view of one embodiment of an inner cutter;

FIG. 2 is a perspective view of a drive cap of the inner cutter of FIG. 1;

FIG. 3 is a side elevation of the drive cap of FIG. 2;

FIG. 4 is a top plan view of the drive cap of FIG. 2;

FIG. 5 is a perspective view of a blade of the inner cutter of FIG. 1;

FIG. 6 is a side elevation of the blade of FIG. 5;

FIG. 7 is a top plan view of the blade of FIG. 5;

FIG. 8 is an enlarged perspective view of a cutting unit of the blade of FIGS. 5-7; and

FIG. 9 is a side elevation of the cutting unit of FIG. 8.

Corresponding reference characters indicate corresponding parts throughout the several views of the drawings.

### DETAILED DESCRIPTION OF THE PREFERRED EMBODIMENTS

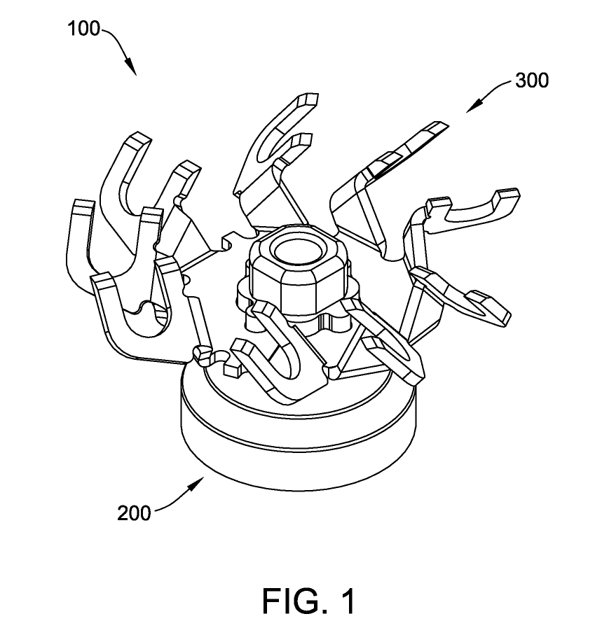

Referring now to the drawings, and in particular to FIG. 1, an inner cutter according to one embodiment is generally indicated by the reference numeral 100. The inner cutter 100 includes a drive cap, generally indicated by reference numeral 200, and a blade generally indicated by reference numeral 300. The blade 300 is fastened to the cap 200. In the illustrated embodiment, the blade 300 is fabricated from a metallic material by suitable stamping and bending processes (as described in more detail below), and the cap 200 is fabricated from a synthetic or semi-synthetic, organic-based material (e.g., a “plastic” material) using a suitable molding process. It is understood, however, that the blade 300 and/or the cap 200 may be fabricated from any suitable material using any suitable manufacturing processes without departing from the scope of this invention.

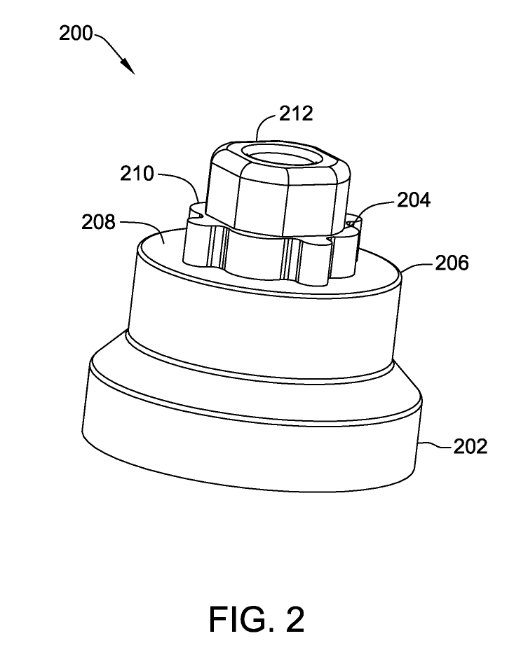

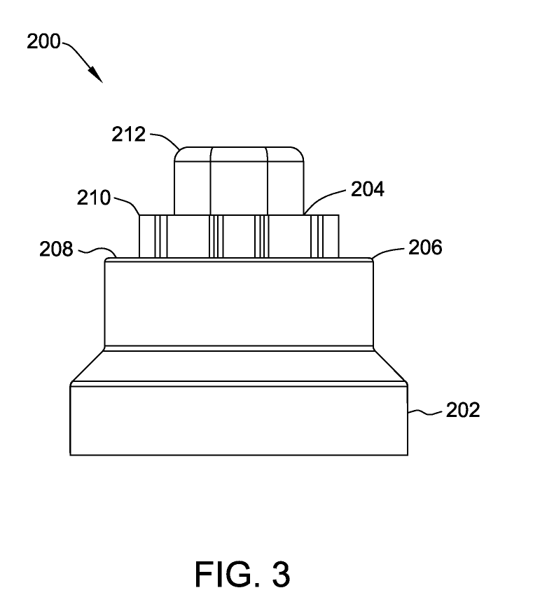

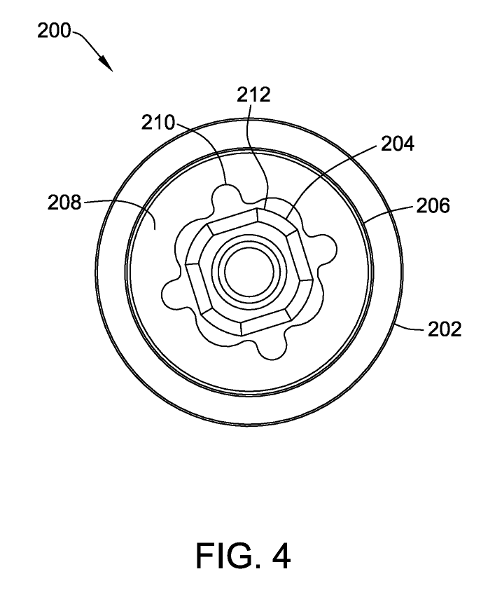

With reference now to FIGS. 2-4, the illustrated cap 200 includes a lower portion 202, an upper portion 204, and an intermediate portion 206 between the lower portion 202 and the upper portion 204. The lower and intermediate portions 202, 206 are generally cylindrical, and the intermediate portion 206 has a rim 208 from which the upper portion 204 projects. The illustrated upper portion 204 has a base 210 and a tip 212. The base 210 is integrally formed with the rim 208 of the intermediate portion 206, and the tip 212 is integrally formed with the base 210. In this embodiment, when viewed from above (FIG. 4), the base 210 has a generally star-shaped profile, and the tip 212 has a generally polygonal profile (e.g., a generally octagonal profile). The base 210 is thus configured for securing the blade 300 to the cap 200 (as described below). In other embodiments, the upper portion 204, the intermediate portion 206, and/or the lower portion 202 may have any suitable shapes and sizes that facilitate enabling the drive cap 200 to function as described herein.

With the blade 300 fastened to the cap 200 (as described below), the inner cutter 100 may be inserted into an outer cutter of a shaver head suitably connected to a shaver handle. Because shaver heads and/or shaver handles typically house components of a shaver drive system (e.g., a motor, a gear arrangement, and/or a drive shaft), at least the lower portion 202 of the cap 200 is hollow to receive a drive pin therethrough for operatively connecting the inner cutter 100 to the shaver drive system. Additionally, the generally polygonal tip 212 is configured to align the inner cutter 100 inside of the outer cutter for rotation of the inner cutter 100 within the outer cutter during operation of the shaver drive system.

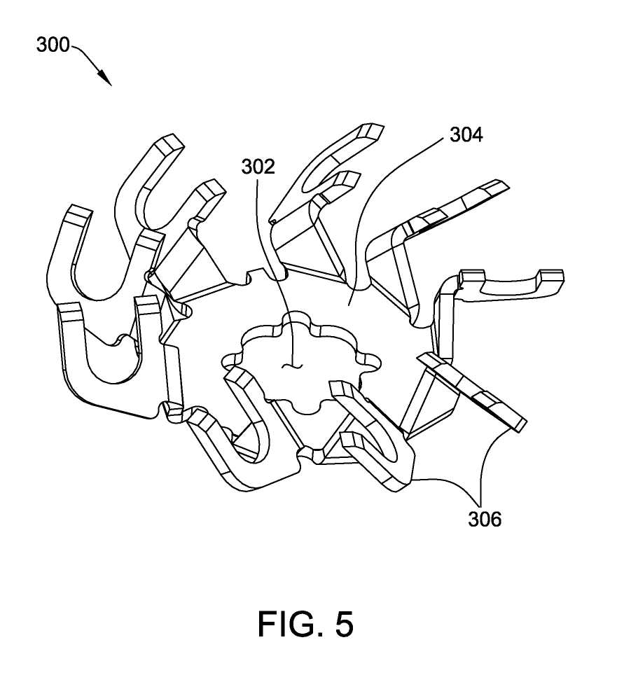

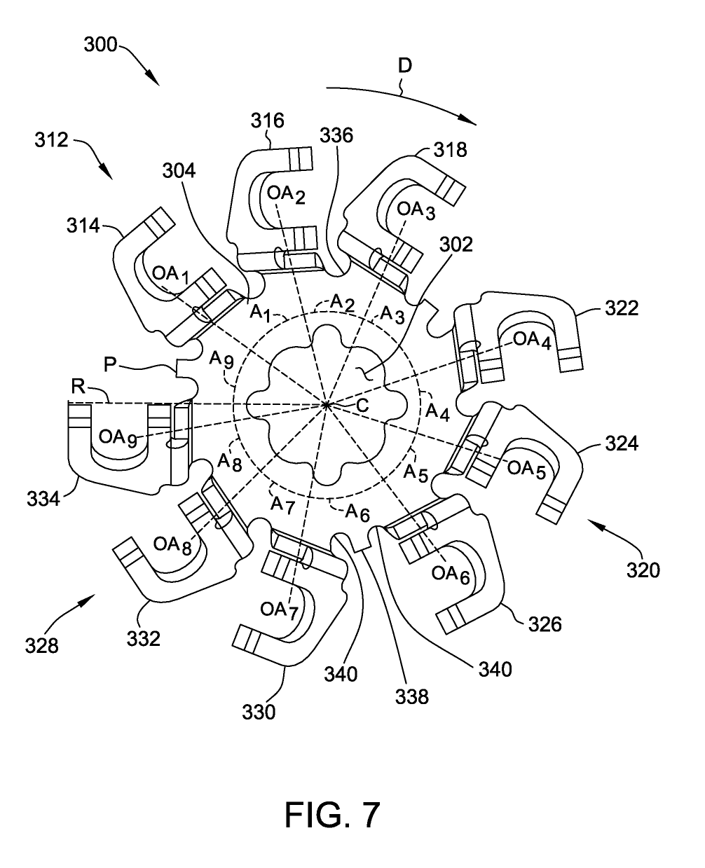

Referring now to FIGS. 5-7, the illustrated blade 300, when viewed from above (FIG. 7) has a generally annular shape with a central aperture 302. In this embodiment, the central aperture 302 is keyed to the shape of the base 210 of the drive cap upper portion 204 (i.e., the central aperture 302 has a generally star-shaped contour that is similar to the generally star-shaped contour of the base 210) such that the base 210 may be inserted into the central aperture 302 (as described below). The central aperture 302 has a center point C, thereby defining a first dimension R (e.g., a radius in the illustrated embodiment) of the annular blade 300, and the blade 300 also has an intended rotational direction D. In other embodiments, the central aperture 302 may have any suitable shape that facilitates interfacing with the base 210 of the drive cap 200 as described herein.

The blade 300 has a base plate 304 and a plurality of cutting units 306 spaced circumferentially about, and extending from, the periphery P of the base plate 304. The base plate 304 and the cutting units 306 are formed integrally together in this embodiment. In other embodiments, the base plate 304 and the cutting units 306 may be formed separately from, and connected to, one another using any suitable connection (e.g., a welded connection).

The base plate 304 has a top surface 308 and a bottom surface 310. In the illustrated embodiment, to fasten the blade 300 to the cap 200, the upper portion 204 of the cap 200 is inserted into the aperture 302 of the blade 300 until the bottom surface 310 of the base plate 304 is seated on the rim 208. Because the star-shaped contour of the base 210 is keyed to the star-shaped contour of the aperture 302, the base 210 can be inserted into the aperture 302, but the base 210 cannot then be rotated relative to the base plate 304 (i.e., the cap 200 is configured to transmit rotational motion from the drive system of the shaver to the blade 300 during operation of the shaver). With the base plate 304 seated on the rim 208, the base 210 is heat staked (or ultrasonically staked) about at least a portion of the star-shaped base 210. This heat staking (or ultrasonic staking) deforms the base 210 over at least part of the perimeter of the aperture 302 to create an interference fit between the cap 200 and the blade 300 once the deformed portion(s) of the base 210 harden, thereby fastening the blade 300 to the cap 200. In other embodiments, the blade 300 may be configured to be fastened to the cap 200 using any suitable method.

In the illustrated embodiment, the blade 300 has nine cutting units 306 that are spaced about the base plate 304 in groups of three. More specifically, the blade 300 includes a first group (generally indicated at 312) of cutting units 306 having a first cutting unit 314, a second cutting unit 316, and a third cutting unit 318; a second group (generally indicated at 320) of cutting units 306 having a fourth cutting unit 322, a fifth cutting unit 324, and a sixth cutting unit 326; and a third group (generally indicated at 328) of cutting units 306 having a seventh cutting unit 330, an eighth cutting unit 332, and a ninth cutting unit 334. In other embodiments, the blade 300 may have any suitable number of groups or cutting units 306 per group. In this embodiment, the cutting units 306 within each group 312, 320, 328 are spaced apart from one another by reliefs 336, and the groups 312, 320, 328 themselves are spaced apart from one another by a tab 338 having a pair of reliefs 340 on opposite sides thereof. Thus, because the groups 312, 320, 328 are spaced apart by a tab 338 and two reliefs 340, while the cutting units 306 within a given group 312, 320, 328 are spaced apart by a single relief 336, the spaces between adjacent groups 312, 320, 328 of cutting units 306 are larger than the spaces between adjacent cutting units 306 within a given group 312, 320, 328. Alternatively, the blade 300 may have any suitable features for spacing cutting units and/or groups of cutting units about the base plate 304.

In the illustrated embodiment, the cutting units 314, 316, 318, 322, 324, 326, 330, 332, 334 have respective orientation axes OA₁, OA₂, OA₃, OA₄, OA₅, OA₆, OA₇, OA₈, OA₉ that extend generally radially from the center C of the base plate 304. These orientation axes OA₁, OA₂, OA₃, OA₄, OA₅, OA₆, OA₇, OA₈, OA₉ are angularly spaced apart from one another by respective angles A₁, A₂, A₃, A₄, A₅, A₆, A₇, A₈, A₉. In this embodiment, while angles A₃, A₆, A₉ are larger than angles A₁, A₂, A₄, A₅, A₇, A₈, all of the angles A₁, A₂, A₃, A₄, A₅, A₆, A₇, A₈, A₉ are suitably different from one another. In other embodiments, the blade 300 may have any suitable quantity, size, shape, location, and/or spacing of cutting units 306. For example, the blade 300 may have nine cutting units 306 that are not arranged in groups of three but, rather, have angular spaces that are progressively smaller about the base plate 304 (e.g., A₁>A₂>A₃>A₄>A₅>A₆>A₇>A₈>A₉). Alternatively, at least two, but not all, of the angles A₁, A₂, A₃, A₄, A₅, A₆, A₇, A₈, A₉ may be the same.

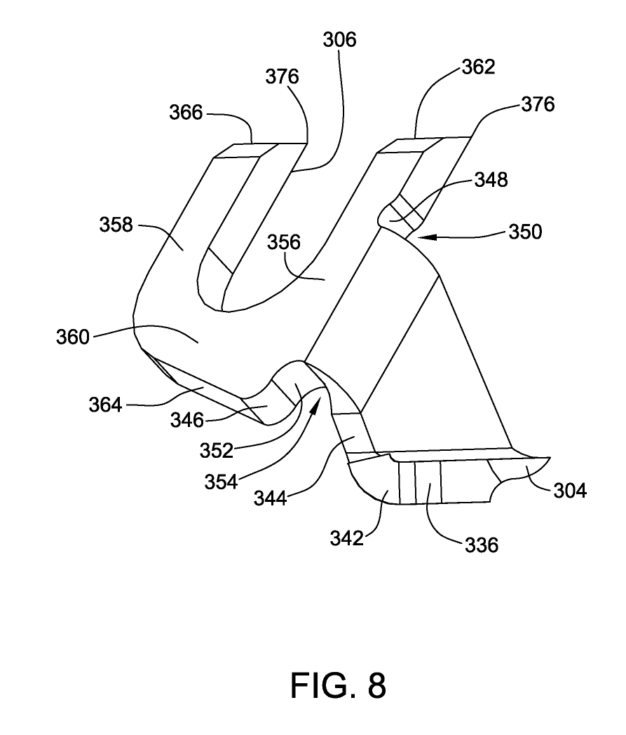

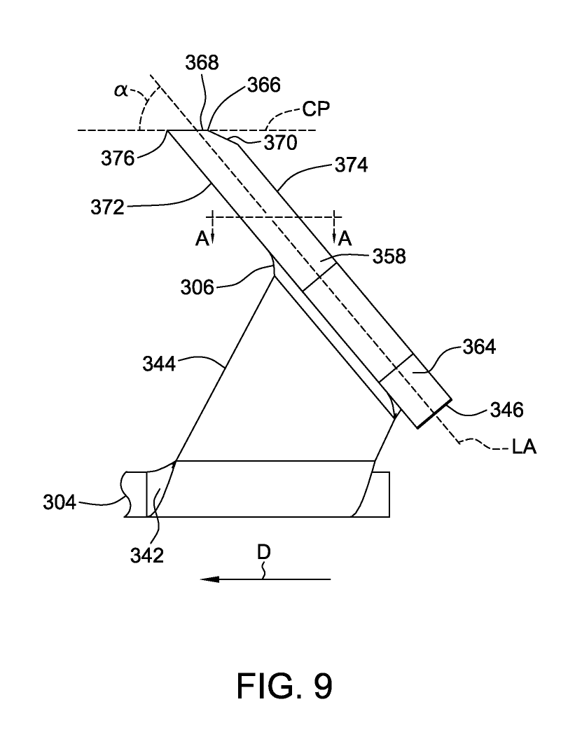

In this embodiment, the blade 300 is manufactured by stamping a flat blade formation from sheet metal and subsequently bending the blade formation to orient the cutting units 306 relative the base plate 304 (i.e., to orient the cutting units 306 as shown in FIGS. 8 and 9). The tabs 338 described above (e.g., the quantity, location, and size of the tabs 338) facilitate locating the stamped blade formation during the bending operation, and the reliefs 336, 340 described above (e.g., the quantity, location, and size of the reliefs 336, 340) facilitate reducing stress applied to the blade formation as the cutting units 306 are bent. Thus, the quantity of cutting units 306 described above (e.g., nine cutting units arranged in groups of three), along with the quantity, location, and size of the reliefs 336, 340 and the tabs 338 described above (e.g., the larger spacing between the groups 312, 320, 328 than between the individual cutting units 306 within each group 312, 320, 328), enable the blade 300 to be fabricated with cutting units 306 having improved structural characteristics (e.g., strengths, cutting efficiencies, etc.). This facilitates more efficient manufacture, more efficient operation, and increased useful life of the blade 300.

FIGS. 8 and 9 are perspective and side elevation views, respectively, of one of the cutting units 306. The cutting units 306 of the blade 300 are unitarily formed with, and bent upwardly and radially relative to, the base plate 304. Each cutting unit 306 has a connecting segment 342, a projecting segment 344, and a cutting member 346 that are integrally formed together. The connecting segment 342 is integrally formed with the base plate 304 such that the connecting segment 342 links the projecting segment 344 and the cutting member 346 to the base plate 304. In other embodiments, the cutting member 346, the projecting segment 344, the connecting segment 342, and/or the base plate 304 may be formed separately from, and connected to, one another using any suitable connection (e.g., a welded connection).

Each connecting segment 342 extends generally radially from the base plate 304, and each projecting segment 344 is bent generally perpendicularly (i.e., upwardly) relative to the connecting segment 342 and the base plate 304. Each cutting member 346 is bent generally perpendicularly (i.e., radially) relative to the projecting segment 344. The cutting member 346 is joined to the projecting segment 344 such that a first relief 348 is formed at an upper junction (generally indicated at 350) of the projecting segment 344 and the cutting member 346 and such that a second relief 352 is formed at a lower junction (generally indicated at 354) of the projecting segment 344 and the cutting member 346, as described in more detail below. Due to the fact that the blade 300 is fabricated by stamping and bending a blade formation from sheet metal of a constant width (as described above), the base plate 304, the connecting segment 342, the projecting segment 344, and substantially all of the cutting member 346 have the same widths. In other embodiments, the blade 300 may be fabricated using any suitable manufacturing processes, and the components of the blade 300 may have any suitable widths.

In this embodiment, each cutting member 346 has a first leg 356, a second leg 358, and a joint region 360 that connects the first leg 356 to the second leg 358. The first leg 356, the second leg 358, and the joint region 360 are integrally formed with one another. The first leg 356 extends from a first top surface 362 of the cutting member 346 to a bottom surface 364 of the cutting member 346, and the second leg 358 extends from a second top surface 366 of the cutting member 346 to the bottom surface 364 of the cutting member 346.

Each of the first and second top surfaces 362, 366 has a planar contact portion 368 and a planar noncontact portion 370. The contact portion 368 extends from a planar front surface 372 of the cutting member 346 to the noncontact portion 370, and the noncontact portion 370 extends from the contact portion 368 to a planar back surface 374 of the cutting member 346 that is substantially parallel to the front surface 372. The contact portion 368 and the noncontact portion 370 are substantially the same length in this embodiment (FIG. 9). In other embodiments, the contact portion 368 and the noncontact portion 370 may have different lengths (e.g., the noncontact portion 370 may be substantially smaller than the contact portion 368, or vice versa, in order to change the overall surface area of the blade 300 that contacts the outer cutter, as described in more detail below).

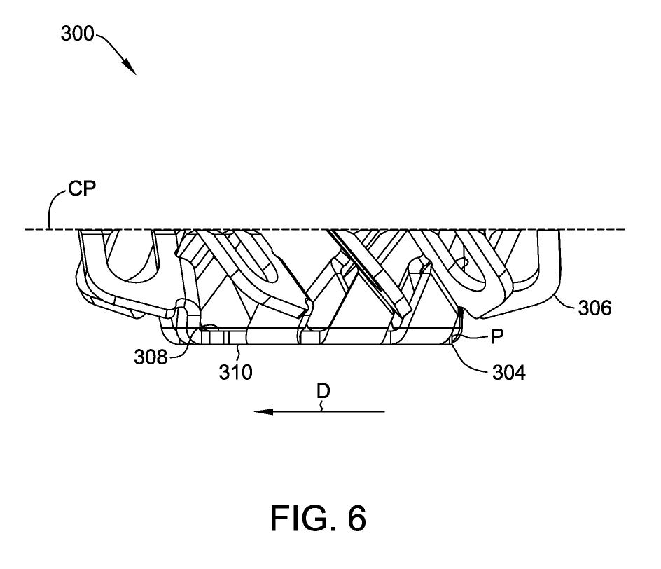

In this embodiment, the contact portions 368 of the cutting units 306 define a contact plane CP (FIGS. 6 and 9). The bottom surface 364 is substantially planar and extends generally in the radial direction at an oblique angle relative to the contact plane CP (FIG. 8) such that the second leg 358 is shorter than the first leg 356. In this manner, a space is provided between the bottom surface 364 of the cutting member 346 and the lower junction 354, which enables the second relief 352 to be spaced apart from the bottom surface 364. The first relief 348 is likewise spaced apart from the first top surface 362 of the cutting member 346. In other embodiments, the bottom surface 364 may have any suitable contour and may have any suitable orientation relative to the contact plane CP.

Again, because the blade 300 is manufactured by stamping a blade formation from sheet metal and subsequently bending the blade formation to orient the cutting units 306 relative to the base plate 304, the reliefs 348, 352 described above (e.g., the location of the reliefs 348, 352 relative to surfaces 362, 364) facilitate reducing stress applied to the blade formation as the cutting members 346 are bent perpendicularly (i.e., radially) relative to the projecting segment 344. In this manner, the reliefs 348, 352 facilitate enabling the blade 300 to be fabricated with cutting units 306 having improved structural characteristics (e.g., strengths, cutting efficiencies, etc.), thereby enabling more efficient manufacture, more efficient operation, and increased useful life of the blade 300.

In this embodiment, the cutting member 346 has a longitudinal axis LA when viewed from the side (FIG. 9). The longitudinal axis LA is angled into the direction of rotation D and is oriented parallel to the front surface 372 and oblique relative to the contact plane CP at an angle α. As such, each contact portion 368 is oriented to be substantially parallel with, and slide smoothly against, inner surfaces of an outer cutter during operation of the shaver, and each noncontact portion 370 is obliquely oriented relative to the contact portion 368 and the back surface 374. In this manner, each leg 356, 358 has a raked cutting edge 376, and each leg 356, 358 is configured such that the surface area of the contact portion 368 is less than the surface area of a section of the finger 356, 358 taken below the noncontact portion 370 and parallel to the contact plane CP. For example, the surface area of the contact portion 368 is less than the surface area of a section of the finger 356, 358 taken along line A-A. Thus, the overall surface area of the blade 300 that is in contact with inner surfaces of the outer cutter can be reduced, which reduces friction and heat generated by the inner cutter 300 contacting the outer cutter during operation. This enables the inner cutters 300 of the shaver to be more easily rotated by the motor, which facilitates conserving battery power.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A blade for an inner cutter of a rotary shaver, said blade comprising:
an annular base plate; and
a plurality of cutting units spaced about the base plate, wherein each of the cutting units has a pair of generally radially spaced-apart cutting edges and an orientation axis, the orientation axes defining a plurality of differently angled spaces about the blade.

2. The blade set forth in claim 1 wherein the blade comprises nine cutting units that define nine differently angled spaces.

3. The blade set forth in claim 1 wherein the cutting units are arranged in a plurality of groups such that the angled spaces between the groups are larger than the angled spaces between the cutting units within the groups.

4. The blade set forth in claim 3 wherein the blade comprises three groups of three cutting units.

5. The blade set forth in claim 3 wherein the groups are spaced apart by a tab and a pair of reliefs on opposing sides of the tab and wherein the cutting units within the groups are spaced apart by a single relief.

6. A blade for an inner cutter of a rotary shaver, said blade comprising:
an annular base plate; and
a plurality of cutting units spaced about the base plate, each of the cutting units comprising a projecting segment extending generally upwardly from the base plate and a cutting member extending generally radially from the projecting segment, wherein a lower relief is defined at a lower junction of the projecting segment and the cutting member.

7. The blade set forth in claim 6 wherein the cutting member comprises a bottom surface, the lower relief being spaced apart from the bottom surface.

8. The blade set forth in claim 7 wherein the cutting member comprises a first leg extending from the bottom surface to a first top surface and a second leg extending from the bottom surface to a second top surface such that the first leg is generally radially spaced apart from the second leg, the projecting segment joined with the first leg.

9. The blade set forth in claim 8 wherein an upper relief is defined at an upper junction of the projecting segment and the first leg and is spaced apart from the first top surface.

10. The blade set forth in claim 8 wherein the top surfaces define a contact plane of the blade, the bottom surface being substantially planar and oriented at an oblique angle relative to the contact plane.

11. The blade set forth in claim 10 wherein the first leg is longer than the second leg.

12. A blade for an inner cutter of a rotary shaver, said blade comprising:
an annular base plate; and
a plurality of cutting units spaced about the base plate, wherein each of the cutting units comprises a front surface, a back surface, and a top surface extending from the front surface to the back surface, wherein the top surface has a planar contact portion and a planar noncontact portion that are obliquely oriented relative to one another.

13. The blade set forth in claim 12 wherein the contact portions of the cutting units define a contact plane of the blade, each of the cutting units having a longitudinal axis oriented at an oblique angle relative to the contact plane such that the front surface and the contact portion of the top surface define a raked cutting edge.

14. The blade set forth in claim 13 wherein the raked cutting edge is acute between the top surface and the front surface.

15. The blade set forth in claim 12 wherein the contact portion and the noncontact portion have substantially the same lengths.

16. The blade set forth in claim 12 wherein the contact portion has a surface area that is less than a surface area of a section of the cutting unit taken below the noncontact portion and parallel to the contact portion.

17. The blade set forth in claim 12 wherein each of the cutting units comprises:
a first leg;
a second leg; and
a joint region connecting the first leg to the second leg such that the first leg and the second leg are substantially parallel to one another in a generally radially spaced-apart relationship to define a first said top surface on said first leg and a second said top surface on said second leg.

18. A method of manufacturing a blade for an inner cutter of a rotary shaver, said method comprising:
stamping a blade formation from a sheet of metallic material, wherein the blade formation includes:
a base plate formation;
a connecting segment formation joined to the base plate formation with a first pair of reliefs disposed on opposite sides of the connecting segment formation at the base plate formation;
a projecting segment formation joined to the connecting segment formation; and
a cutting member formation joined to the projecting segment formation with a second pair of reliefs disposed on opposite sides of the projecting segment formation at the cutting member formation;
bending the projecting segment formation relative to the connecting segment formation such that the projecting segment formation extends generally upward relative to the connecting segment formation; and
bending the cutting member formation relative to projecting segment formation such that the cutting member formation extends generally radially from the projecting segment formation.

19. The method set forth in claim 18 wherein said bending the cutting member formation relative to the projecting segment formation comprises bending the cutting member formation such that the cutting member formation has a longitudinal axis that is obliquely oriented relative to a contact plane of the blade.

20. The method set forth in claim 18 wherein stamping a blade formation comprises stamping the blade formation such that the blade formation includes a plurality of tabs on the base plate formation, said method further comprising locating the blade formation using the tabs during said bending the projecting segment formation and said bending the cutting member formation.
